(19) United States
(12) Patent Application Publication
(10) Pub. No.: US 2013/0146014 A1
(43) Pub. Date: Jun. 13, 2013

(54) Two-Cylinder Engine

(71) Applicant: Younghun AHN, Seoul (KR)

(72) Inventor: Younghun AHN, Seoul (KR)

(73) Assignee: Hyundai Motor Company, Seoul (KR)

(21) Appl. No.: 13/531,278

(22) Filed: Jun. 22, 2012

(30) Foreign Application Priority Data
Dec. 9, 2011 (KR) 10-2011-0132287

(51) Int. Cl. F02B 75/06

(52) U.S. Cl. 123/192.2

(57) ABSTRACT

A two-cylinder engine is configured to reduce vibration. The two-cylinder engine includes a piston, a piston pin, a crankshaft of which a rotation center is positioned at a first predetermined distance from an imaginary center line of a cylinder, and a balance shaft of which a rotation center is positioned at a predetermined angle from an imaginary line perpendicular to the imaginary center line of the cylinder around the rotation center of the crankshaft for abutting onto a vehicle mounting position so as to reduce vibration.

### CROSS-REFERENCE TO RELATED APPLICATION

The present application claims priority of Korean Patent Application Number 10-2011-0132287 filed Dec. 9, 2011, the entire contents of which application is incorporated herein for all purposes by this reference.

### BACKGROUND OF INVENTION

1. Field of Invention

The present invention relates to a two-cylinder engine. More particularly, the present invention relates to a two-cylinder engine which may reduce vibration.

2. Description of Related Art

In a general two-cylinder engine, since two pistons simultaneously move in the same direction, vibration is more serious than in other multiple-cylinder engines, for example, a four-cylinder engine, a six-cylinder engine, an eight-cylinder engine, and so on.

Also, since two-cylinder engines are generally applied to a light or small vehicle, weight reduction is more important. Therefore, mounting an apparatus for preventing vibration from transmitting to a vehicle is limited. Thus, it is required to develop a two-cylinder engine which basically may not generate vibration.

Also, a tendency to downsize an engine is a big issue recently due to environmental problems, and thus two-cylinder engines which may reduce vibration are under constant investigation.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a two-cylinder engine which may reduce vibration.

Various aspects of the present invention provide for a two-cylinder engine including a piston and a piston pin that may include a crankshaft of which a rotation center is positioned at a first predetermined distance from an imaginary center line of a cylinder, and a balance shaft of which a rotation center is positioned at a predetermined angle from an imaginary line perpendicular to the imaginary center line of the cylinder around the rotation center of the crankshaft for abutting onto a vehicle mounting position so as to reduce vibration.

The predetermined angle may be 20° to 30°.

The first predetermined distance may be 3 to 7 mm.

A sum of moments of inertia of the crankshaft and the balance shaft may be substantially the same as a moment of inertia of the piston, and a relative difference between the moment of inertia of the crankshaft and the moment of inertia of the balance shaft may be less than 5%.

The piston pin connecting the piston and the crankshaft may be positioned at a second predetermined distance from the imaginary center line of the cylinder.

The second predetermined distance may be 0.4 to 0.8 mm.

Various aspects of the present invention provide for a two-cylinder engine including a piston and a piston pin that may include a crankshaft of which a rotation center is positioned at a first predetermined distance from an imaginary center line of a cylinder, and a balance shaft of which a rotation center is positioned at a predetermined angle from an imaginary line perpendicular to the imaginary center line of the cylinder around the rotation center of the crankshaft for abutting onto a vehicle mounting position so as to reduce vibration, wherein the predetermined angle may be 20° to 30° and the first predetermined distance may be 3 to 7 mm.

A sum of moments of inertia of the crankshaft and the balance shaft may be substantially the same as a moment of inertia of the piston, and a relative difference between the moment of inertia of the crankshaft and the moment of inertia of the balance shaft may be less than 5%.

The piston pin connecting the piston and the crankshaft may be positioned at a second predetermined distance from the imaginary center line of the cylinder, wherein the second predetermined distance may be 0.4 to 0.8 mm.

As described above, a two-cylinder engine according to various aspects of the present invention may reduce vibration and may reduce weight of an engine without an additional apparatus for reducing vibration.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a front view of an exemplary two-cylinder engine according to the present invention.

FIG. 2 is a drawing showing a piston and a piston pin of an exemplary two-cylinder engine according to the present invention.

FIG. 3 is a drawing showing a moment of inertia of an exemplary two-cylinder engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

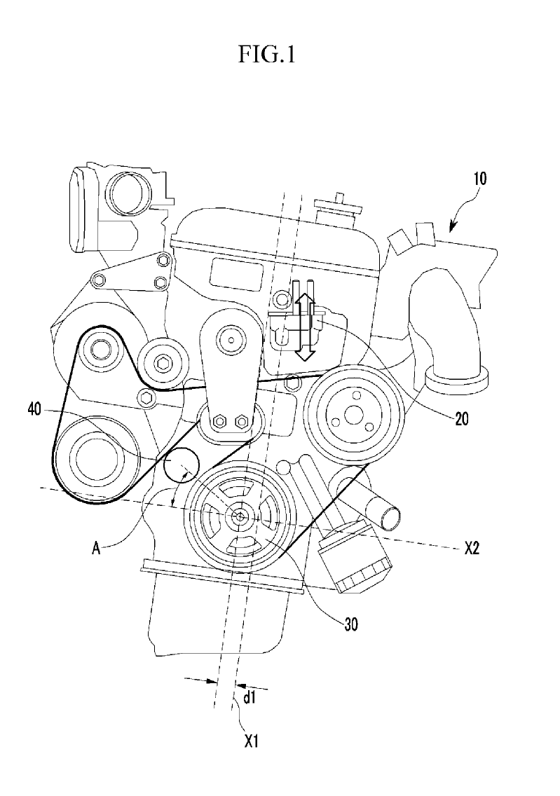

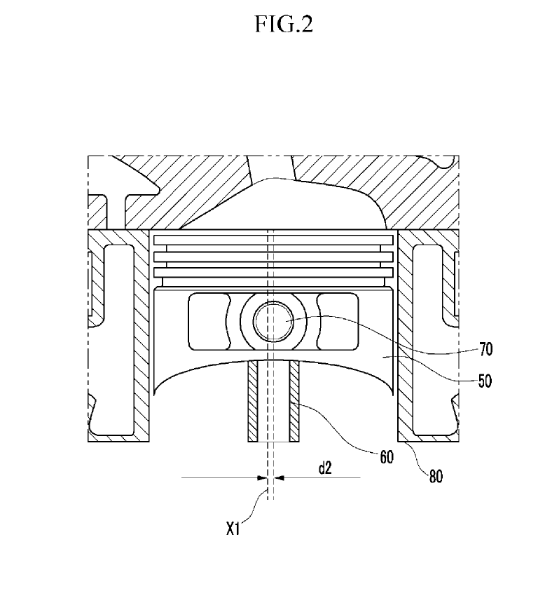

FIG. 1 is a front view of a two-cylinder engine according to various embodiments of the present invention, and FIG. 2 is a drawing showing a piston and a piston pin of a two-cylinder engine according to various embodiments of the present invention.

Hereinafter, referring to FIG. 1 to FIG. 2, a two-cylinder engine according to various embodiments of the present invention will be described.

A two-cylinder engine 10 according to various embodiments of the present invention include a piston 50, a piston pin 70, a crankshaft 30 of which a rotation center is positioned at a first predetermined distance d1 from an imaginary center line X1 of a cylinder 80, and a balance shaft 40 of which a rotation center is positioned at a predetermined angle A from an imaginary normal X2, that is, a line X2 that is perpendicular to the imaginary center line X1 of the cylinder 80 around the rotation center of the crankshaft 30 for abutting onto a vehicle mounting position 20 so as to reduce vibration.

In the drawing, the two-cylinder engine 10 is inclined, and this is an example of mounting an engine to a vehicle. However, it is not limited thereto.

The predetermined angle may be 20° to 30°.

When the position of the balance shaft 40 is as described above, the balance shaft 40 is relatively close to the vehicle mounting position 20 where the vibration generated from the engine 10 is transmitted to a vehicle such as through a mounting bracket. Thus the relative moment to the vehicle mounting position 20 may be reduced, and the total size of the two-cylinder engine 10 may be reduced such that engine room layout is much easier.

The first predetermined distance d1 may be 3 to 7 mm.

If the first predetermined distance d1 is reduced, the relative distance between the crankshaft 30 and the vehicle mounting position 20 and thus the relative moment of the crankshaft 30 to the vehicle mounting position 20 may be reduced. However, if the first predetermined distance d1 is excessively short, a lateral force of a piston is increased so that the vibration is increased. Therefore, the first predetermined distance d1 is determined to be 3 to 7 mm.

Referring to FIG. 2, the piston 50 and the crankshaft 30 are connected by the piston pin 70 and a connecting rod 60. The piston pin 70 is positioned at a second predetermined distance d2 from the imaginary center line X1 of the cylinder 80, and the second predetermined distance d2 may be 0.4 to 0.8 mm.

Since behavior of a two-cylinder engine is similar to a single-cylinder engine, and thus the effect of the second predetermined distance d2 is considerable, so the second predetermined distance d2 is determined to be 0.4 to 0 8 mm considering impact, noise, vibration, and so on between the piston 50 and a cylinder 80.

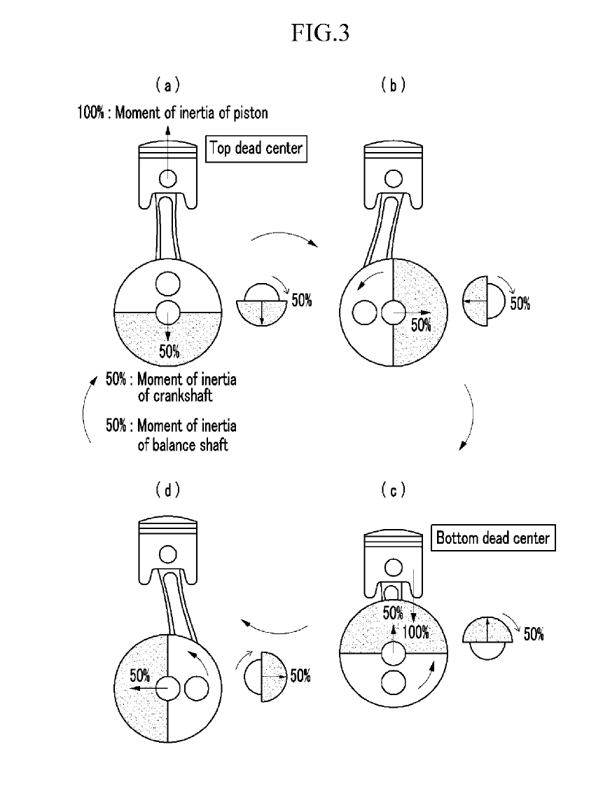

FIG. 3 is a drawing showing a moment of inertia of a two-cylinder engine according to various embodiments of the present invention.

As shown in FIG. 3, if the moment of inertia of a piston at top dead center and bottom dead center is 100%, each moment of inertia of the crankshaft 20 including balance weights and the moment of inertia of the balance shaft 40 may be substantially 50%, and thus imbalance of the moment of inertia may be countervailed.

That is, a sum of moments of inertia of the crankshaft 20 and the balance shaft 40 is substantially the same as the moment of inertia of the piston 50, and a relative difference between the moment of inertia of the crankshaft 20 and the moment of inertia of the balance shaft 40 is less than 5% so that imbalance of the moment of inertia may be countervailed.

In this case, the distribution of the moment of inertia of the crankshaft 20 and the balance shaft 40 may be calculated using a relative distance from the rotation center and each mass, or may be determined by experiments. The distribution of the moment of inertia may be achieved by a person skilled in the art, and thus a detailed explanation will be omitted.

As described above, the two-cylinder engine according to various embodiments of the present invention may reduce vibration by determination of the positions of the balance shaft, the crankshaft, and the piston pin, and by the distribution of the moment of inertia.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A two-cylinder engine comprising:
a cylinder having a center line;
a piston reciprocally received in the cylinder, the piston including a piston pin;
a crankshaft having a crankshaft rotation center positioned at a first predetermined distance from the center line of the cylinder; and
a balance shaft having a shaft rotation center positioned at a predetermined angle from a normal line of the cylinder center line around the crankshaft rotation center for abutting onto a vehicle mounting position so as to reduce vibration.

2. The two-cylinder engine of claim 1, wherein the predetermined angle is 20° to 30°.

3. The two-cylinder engine of claim 1, wherein the first predetermined distance is 3 to 7 mm.

4. The two-cylinder engine of claim 1, wherein a sum of moments of inertia of the crankshaft and the balance shaft is substantially the same as a moment of inertia of the piston, and
a relative difference between the moment of inertia of the crankshaft and the moment of inertia of the balance shaft is less than 5%.

5. The two-cylinder engine of claim 1, wherein the piston pin connecting the piston and the crankshaft is positioned at a second predetermined distance from the imaginary center line of the cylinder.

6. The two-cylinder engine of claim 2, wherein the second predetermined distance is 0.4 to 0.8 mm.

7. A two-cylinder engine comprising:
cylinder having a center line;
a piston reciprocally received in the cylinder, the piston including a piston pin;
a crankshaft having a crankshaft rotation center positioned at a first predetermined distance from the cylinder center line; and
a balance shaft having a shaft rotation center positioned at a predetermined angle from a normal line of the cylinder center line around the rotation center of the crankshaft for abutting onto a vehicle mounting position so as to reduce vibration;
wherein the predetermined angle is 20° to 30° and the first predetermined distance is 3 to 7 mm.

8. The two-cylinder engine of claim 7, wherein a sum of moments of inertia of the crankshaft and the balance shaft is substantially the same as a moment of inertia of the piston, and
a relative difference between the moment of inertia of the crankshaft and the moment of inertia of the balance shaft is less than 5%.

9. The two-cylinder engine of claim 7, wherein the piston pin connecting the piston and the crankshaft is positioned at a second predetermined distance from the imaginary center line of the cylinder,
wherein the second predetermined distance is 0.4 to 0.8 mm.
